(19) United States
(12) Patent Application Publication
(10) Pub. No.: US 2008/0205973 A1
(43) Pub. Date: Aug. 28, 2008

(54) Leaf Sheet

(76) Inventor: Clyde Marvin Drawdy, Lexington, SC (US)

Correspondence Address: Clyde M. Drawdy, 210 Hendrix Street, Lexington, SC, 29072, US

(21) Appl. No.: 11/710,632

(22) Filed: Feb. 26, 2007

(51) Int. Cl. B42F 13/00

(52) U.S. Cl. 402/80 L

(57) ABSTRACT

The leaf Sheet allows a single individual to expeditiously contain and dispose of piles of leaves and/or other debris. An individual using the Leaf Sheet can actually work more efficiently and faster alone than with one or more other persons assisting while using the same Leaf Sheet. When the volume of leaves contained exceeds the capacity of one individual to lift, the Leaf Sheet provides lift handles to accommodate the removal of the leaves to a place of disposal. The Leaf Sheet is far more efficient and easy to use than the conventional leaf bag.

### CROSS-REFERENCE TO RELATED APPLICATIONS

Not Applicable

### FEDERALLY SPONSORED RESEARCH OR DEVELOPMENT

Not Applicable

### SEQUENCE LISTINGS

Not Applicable

### BACKGROUND OF INVENTION

The Leaf Sheet is a household item used expressly for yard work and specifically for removal of fallen leaves, but it can be used for other purposes as well. The Leaf Sheet is in the “Home and Garden” category of household products. Besides being used in the home, businesses and institutions with real estate that includes trees and other leaf bearing plants will also find the Leaf Sheet very useful.

### BRIEF SUMMARY OF THE INVENTION

The Leaf Sheet allows an individual to contain raked and piled leaves entirely without the aid of another individual and with little to no spillage of the leaves during the containment process. The leaf Sheet provides a huge advantage over the conventional leaf bag since none of the leaves have to be lifted from the ground to be contained. Using the Leaf Sheet one simply rakes the leaves directly onto the sheet. The Leaf Sheet comes double folded according style. The user simply places the Leaf Sheet on the ground at any point beside the leaf pile and inserts the exposed thumb spike by pressing the sharp end into the ground. An arrow shows the user which direction to pull the Leaf Sheet to complete the first unfold. Once unfolded the user inserts the second thumb spike into the ground along the side of the leaf pile. The first unfold exposes another arrow showing the user which direction to pull the Leaf Sheet for the second and final unfold. The second unfold positions the opposite end of the Leaf Sheet out and away from the leaf pile. After the second unfold the user then presses the two remaining thumb spikes into the ground. With the four thumb spikes inserted into the ground the Leaf Sheet is held securely against the ground preventing normal winds from lifting the sheet and providing the full 7½ by 8 feet of surface space to be used for the containment of leaves. Once the user has raked all desired leaves onto the Leaf Sheet he/she will grab any two cross opposite end corners and using the reinforced hand ties tie the two corners together. The user will then repeat the process for the two remaining cross opposite corners. The user now has the leaves completely contained. The tying of the four cross opposite end corners together will reveal the reinforced lift handles on each side of the tied up Leaf Sheet. The reinforced lift handles will allow a second person when necessary, based on the volume of the leaves tied up, to assist with the lifting and removal of the leaves to the desired place of disposal.

### BRIEF DESCRIPTION OF THE SEVERAL VIEWS OF THE DRAWINGS

FIG. 1—Leaf Sheet view showing full size, reinforced hand ties, thumb spikes and reinforced lift handles.

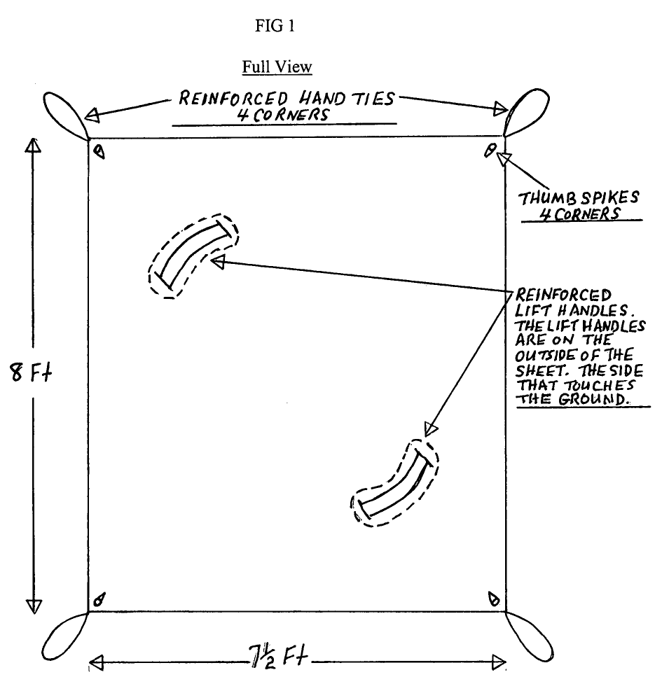

FIG. 2—Leaf Sheet corners showing close-up of reinforced hand ties and thumb spikes.

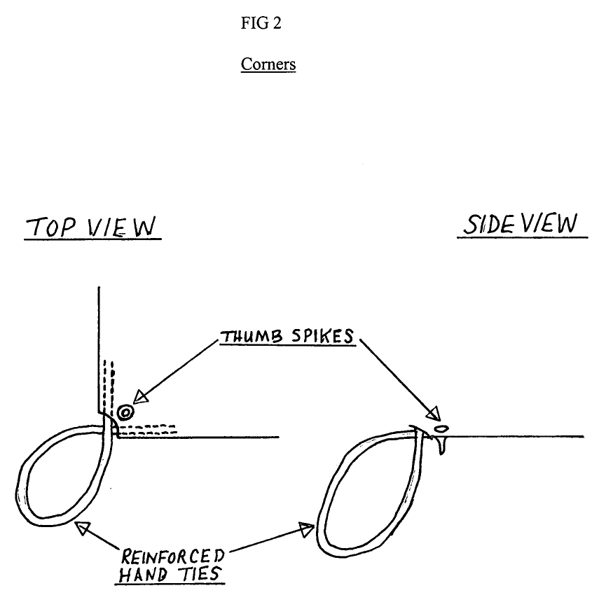

FIG. 3—Leaf Sheet showing manufacturer first fold with side and top view.

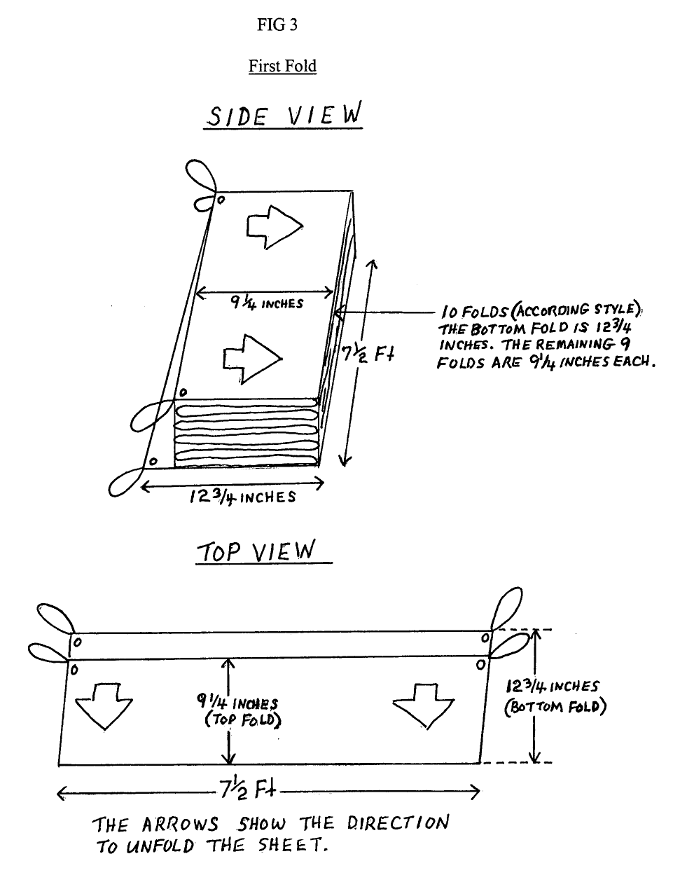

FIG. 4—Leaf Sheet showing manufacturer second fold with side and top view.

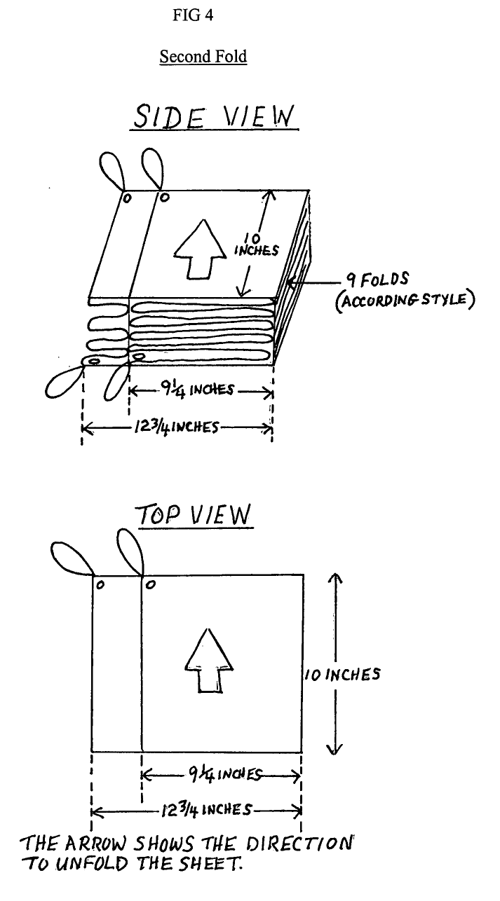

FIG. 5—Leaf Sheet showing the two unfold moves.

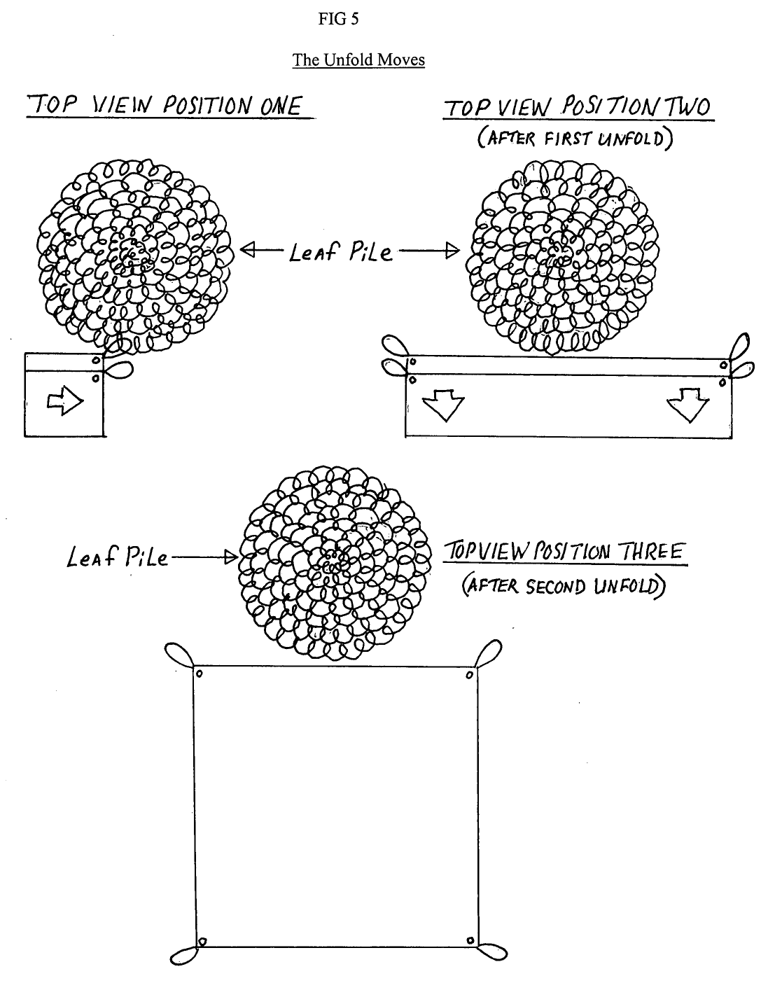

### DETAIL DESCRIPTION OF THE INVENTION

The Leaf Sheet is made from the same type and weight of plastic used to make leaf bags. The Leaf Sheet size is 7½ feet by 8 feet. The four corners of the Leaf Sheet have reinforced hand ties. The four corners of the Leaf Sheet have thumb spikes. The thumb spikes are one half the length of a regular golf tee. The Leaf Sheet has reinforced lift handles on either side. The Leaf Sheet is folded by the manufacturer in such a way that the person using the sheet needs only two moves to completely unfold and use the sheet. The first unfold moves the sheet along side of the leaf pile. Two of the four thumb spikes are pushed into the ground after the first unfold. The second unfold moves the sheet out and away from the leaf pile. The remaining two thumb spikes are pushed into the ground after the second unfold. When all four thumb spikes are pushed into the ground the sheet is held smooth against the ground allowing the full length and width of the sheet to be used to contain leaves. Once the leaf pile has been raked onto the sheet the person uses the reinforced hand ties to tie cross opposite corners of the sheet together and then repeats that process for the remaining two corners. The leaf pile is now contained in the Leaf Sheet. The tying up of the four corners of the Leaf Sheet exposes the lift handles on either side of the sheet. The lift handles are necessary when the volume and weight of the leaf pile requires another individual to assist in lifting the contained leaves to move them to a place of disposal.

I. I claim the Leaf Sheet to be the first non-mechanical tool designed specifically to allow the containment of leaves and other debris by raking the leaves and other debris onto the tool eliminating the need to lift and place the leaves and other debris onto a container.

II. I claim the combination of amenities attached to the Leaf Sheet, which is the reinforced hand ties, the thumb spikes, and the reinforced lift handles make the Leaf Sheet a unique tool for the use in containment and disposal of leaves and other debris.
